(19) United States
(12) Patent Application Publication
(10) Pub. No.: US 2021/0117409 A1
(43) Pub. Date: Apr. 22, 2021

(54) AUTOMATED CONTENT GENERATION FROM STATISTICAL DATA

(71) Applicant: Rovi Guides, Inc., San Jose, CA (US)

(72) Inventors: Lance G. O'Connor, Sunnyvale, CA (US); Alan Waterman, Merced, CA (US)

(21) Appl. No.: 16/658,510

(22) Filed: Oct. 21, 2019

(51) Int. Cl. G06F 16/23; G06F 16/2455; G06F 16/248; G06N 3/04

(52) U.S. Cl. CPC G06F 16/2379; G06N 3/04; G06F 16/248; G06F 16/24558

(57) ABSTRACT

Systems and methods are provided for generating content for sports data. The system accesses a play statistic item, the play statistic item including a player name, play duration, and play description. The system searches a plurality of content structures for a matching content structure that includes an object that matches the player and comprises an attribute that matches the play description, and a mapping of the object matches the play statistic item. When a matching content structure is found, the system adds the object and the mapping to a new content structure. Then, the system generates for output a content segment based on the new content structure.

### BACKGROUND

The present disclosure is directed to techniques for automatic generation of a content segment, and in particular to automatic generation of a content segment based on statistical data (e.g., based on sports statistics).

### SUMMARY

Users often interact with statistical information generated based on a content item (e.g., statistics of a recorded sports match). Displaying such statistical information in a visual for is time-consuming and expensive. One approach required a human artist to use digital animation tools to produce a depiction of the statistics. Such manual approach will commonly require manual creation of models as well as labor-intensive programming to define attributes, motion paths, and features of the hand-drawn models that match the statistical data. This approach does not leverage existence of already-generated content structures that were previously based on similar content items. For example, large libraries of content structures for sports matches may already exist. Such libraries can be used to generate graphics for statistical information from a new sports match and thus avoid the need of manual generation of graphic depiction of the statistics.

Accordingly, techniques are disclosed herein for generating and presenting content segments based on statistics by leveraging an existing library of content structures. Generation techniques that can be used for generating new content structures and rendering content structures into a content segment are described by co-pending application Ser. No. 16/451,823 ('823 application hereinafter) entitled “SYSTEMS AND METHODS FOR CREATING CUSTOMIZED CONTENT,” filed on Jun. 25, 2019, which is hereby expressly incorporated by reference herein in its entirety.

In particular, techniques described herein may be used to generate a content segment for sports statistical data using a library of pre-existing content structures that were generated based on other similar sports matches. In some embodiments, a statistics analysis engine may access a play statistic item, the play statistic item comprising a player name, play duration, and play description (e.g., a play-by-play statistic item). For example, the play statistic item may be accessed from a server that reports sports results for recently completed games.

After accessing the play statistic item, the statistics engine searches a library of content structures for a matching content structure. For example, a large sample of sports matches may have been previously deconstructed using a deconstruction engine as described in the '823 application to generate the library. The library will thus include content structures generated based on games and including objects having features and related mapping as described in the '823 application.

In some embodiments, the statistics analysis engine will search for a matching structure that includes an object with features that match the player and comprises an attribute that matches the play description. For example, the statistics analysis engine may compare the feature “name” of an object to the name of the player to identify a matching object. The statistics analysis engine may also check the object for attributes matching the play description. For example, this may be accomplished using natural language processing. The statistics analysis engine may also check mapping of matching features for a compatible mapping. For example, the statistics analysis engine may check whether the mapping matches the play duration.

Once a matching content structure is found, the statistics analysis engine adds the matching object of the matching content structure to a new content structure. In some embodiments, the statistics analysis engine may process all (or some) statistic items of a game (e.g., a football game) and add all matching objects to the new content structure. In this way, the statistics analysis engine creates a content object that encodes the entire game.

Subsequently, a construction engine (as described by the '823 application) may be used to generate for output a content segment based on a new content structure (which may then be displayed). In this way, a content segment is automatically generated to summarize or even to replay a game based on statistics. In some embodiments, the process may be performed based on statistics of a “fantasy” game, to generate a visualization of how the fantasy game would have played it if it had really taken place.

### BRIEF DESCRIPTION OF THE DRAWINGS

The below and other objects and advantages of the disclosure will be apparent upon consideration of the following detailed description, taken in conjunction with the accompanying drawings, in which like reference characters refer to like parts throughout, and in which:

FIG. 1 shows an illustrative example for generating a content structure based on statistics, in accordance with some embodiments of the disclosures;

FIG. 2 shows another illustrative example for generating a content structure based on statistics, in accordance with some embodiments of the disclosure;

FIG. 3 shows an illustrative user interface for generating a content structure based on statistics, in accordance with some embodiments of the disclosure;

FIG. 4 shows an illustrative system diagram of the statistics engine, the content structure, the construction engine, the content segment, and devices, in accordance with some embodiments of the disclosure;

FIG. 5 shows an illustrative block diagram of the statistics engine, in accordance with some embodiments of the disclosure;

FIG. 6 shows an illustrative block diagram of the construction engine, in accordance with some embodiments of the disclosure;

FIG. 7 is an illustrative block diagram of a neural net, in accordance with some embodiments of the disclosure; and

FIG. 8 is an illustrative flowchart of a process for creating content based on one or more previously stored content structures, in accordance with some embodiments of the disclosure.

### DETAILED DESCRIPTION

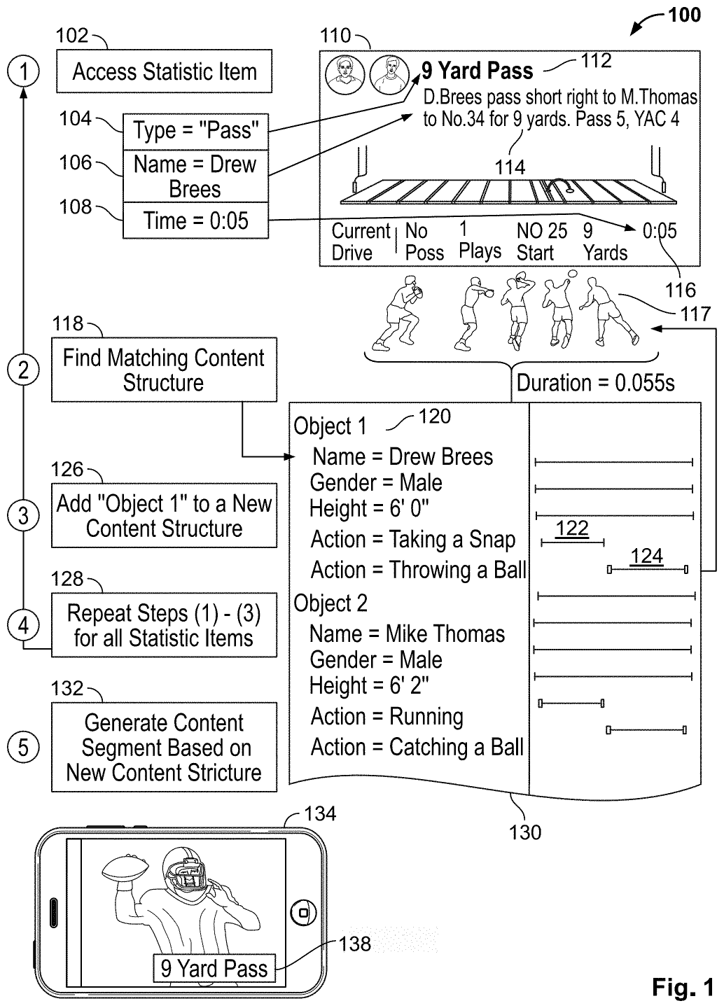

FIG. 1 shows an illustrative example 100 for generating a new content structure based on statistics. In some embodiments, the statistics analysis engine may access 102 statistics item 110. For example, the statistics may be extracted from a play-by-play report of a football game (e.g., as reported by a league website or by a sports database). In some embodiments, the statistic item may be a “fantasy” item generated by the user or by a fantasy sports website. For example, as shown, a statistic is extracted from the website that lists Drews Brees executing a 9-yard pass 112 to Michael Thomas 114 in a play that took 5 seconds 116. As shown, the statistic item may include type of a play 104 (e.g., “pass”), name of the player 106 (e.g., “Drew Brees”), and play duration 108 (e.g., “5 seconds”). Further play description may also be obtained.

At 118, the statistics analysis engine may search a library of content structures that match the statistical item 110. In some embodiments, the statistics analysis engine searches a set of content structures that were generated by a construction engine (e.g., as described in the '823 application) based on recordings of multiple past football games. For example, the statistics analysis engine may identify matching content item 130. In some embodiments, matching content item 130 may have been created by a deconstruction engine based on a recording of another game (e.g., another game involving Drew Brees).

The statistics analysis engine may determine that matching content item 130 comprises matching objects 120 based on object 120 comprising an attribute “Drew Brees” that is the same as the name of the player from statistic item 110. In some embodiments, the statistics analysis engine may look for an object that has attributes that match physical attributes of Drew Brees. For example, an object may match statistic item 110 if it includes gender, height, and weight that sufficiently closely (e.g., within 5%) match physical features of Drew Brees (e.g., as listed in a player database).

The statistics analysis engine may further determine that matching content item 130 comprises matching object 120 based determining that object 120 includes an attribute that matches the play description of statistic item 110. For example, using natural language programming, the statistics analysis engine may determine that attributes “taking a snap” and “throwing the ball” are equivalent to the play description “pass.”

The statistics analysis engine may further determine that matching content item includes a mapping that matches play statistic item 110. For example, statistics analysis engine may check whether the mapping of the matching attributes of object 120 (e.g., action attributes) have a total duration that matches the play duration of statistic item 110. For example, the statistics analysis engine may add the duration of mapping 122 and mapping 124 and compare the sum to play duration 108. In some embodiments, if the durations are within a certain threshold (e.g., 10%), the statistics analysis engine identifies a match. In some embodiments, statistics analysis engine may utilize a neural net to identify matches between the mapping and the statistic item, as will be explained below (e.g., with respect to FIG. 7).

At 126, if a matching object (e.g., object 130) is found, it is added to a new content structure. For example, the new content structure may include object 1, all its features and all related mappings. In this way, the new content structure has copied a description of a play from another video to emulate the action encoded by statistic item 110. That is, an action sequence 117 (as encoded by mapping 122 and 124) may be a close representation of a play that resulted in statistic item 110 (e.g., it also shows Drew Brees, or a similar player, throwing a ball to a receiver). In some embodiments, if multiple matches are available, the statistics analysis engine may select the one that matches the best (e.g., has the pass go to the same receiver as in the statistic item 110, has the ball travel the same distance when thrown as in statistic item 110, etc.).

At 128, steps 102, 118, and 126 may be repeated for all or some available statistic items (e.g., for all items available for a certain game). The more objects become added to the new data structure, the more closely the new structure represents the game. When the new structure is constructed, a construction engine (e.g., the construction engine as described in the '823 application) may be used to generate a content segment at 132. The content segment may be played on a user device 134 to provide a visual depiction that is based on statistics without the need to manually animate the statistics. In some embodiments, the content segment may be supplemented with overlay 138 from data in statistics item 110.

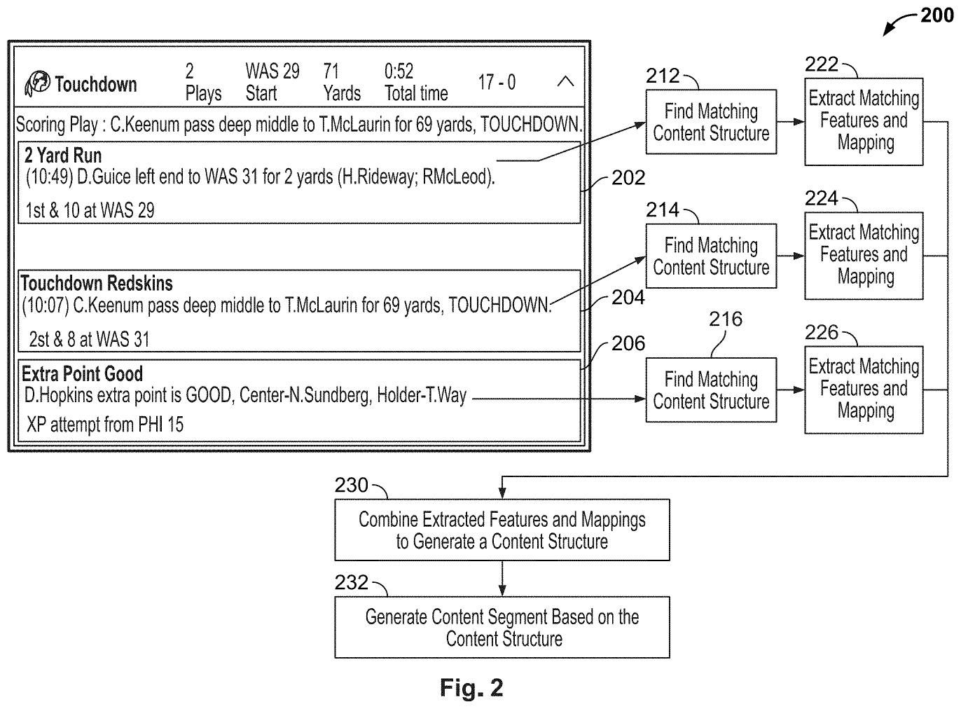

FIG. 2 shows another illustrative example 200 for generating a content structure based on statistics. As shown, the statistics analysis engine may process multiple statistic items 202-206 (e.g., from the same real football game or from the same fantasy game).

For example, at 212, the statistics analysis engine may find an object in a library of content structures that encodes D. Guice (or a similar player) running for 2 yards. Similarly, at 214, the statistics analysis engine may find an object in the library of content structures that encodes C. Keenum (or a similar player) throwing a long touchdown pass. Similarly, at 216, statistics analysis engine may find an object in library of content structures that encodes D. Hopkins (or a similar player) kicking an extra point. The matching object may be identified as described above with respect to step 118 of FIG. 1.

At 222-226, the statistics analysis engine may extract matching objects from content structures identified in steps 212-216. For example, matching objects may be extracted one by one, or at the same time. In some embodiments, all features of each object are extracted. In some embodiments, only key features (e.g., those related to the statistic item) are extracted.

At 230, the statistics analysis engine may combine the extracted objects (with their features and mapping) to generate a new content structure. At 232, a construction engine may be used to generate the content segment based on the new content structure. In some embodiments, the construction engine may be used to render a content structure into a content segment that may be played on user equipment as described in the '823 application. The content segment may fully encode the plays 202-206, such that a user can watch the summary or the whole game.

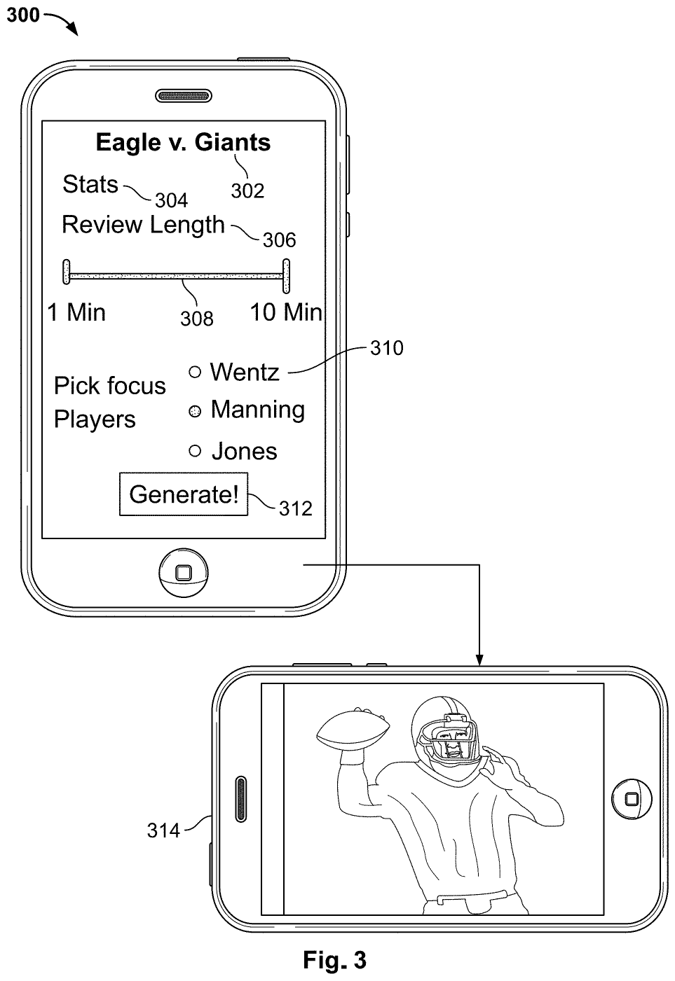

FIG. 3 shows an illustrative user interface 300 of a device for generating a content structure based on statistics. User interface 300 may identify game 302 that is to be summarized. User interface 300 may include button 304 for showing all statistics. For example, when button 304 is pressed, statistic items 202-206 are shown on user interface 300.

User interface 300 may include slider 308 for selecting review length 306. For example, the user may select the review to be between 1 minute and 10 minutes using slider 308. When a review length is selected, the statistics analysis engine may generate the new content structure by selecting plays such that the matching mapping (e.g., that was identified as described in step 118) with the total length equal to or similar to (e.g., within 5%) the selected review length 306. That is, if a 5 minutes review is selected, the statistics analysis engine may select objects with mappings having total lengths that add up to 4 minutes and 50 seconds.

User interface 300 may include selection toggle 310 of a focus player (e.g., a player proffered by the user). When a focus player is selected, the statistics analysis engine may generate the new content structure by selecting only plays that included the focus player. In this way the resulting content segment will provide a review of one player's actions. User interface 300 may include “generate” button 312, used to initiate generation of the content segment based on statistics shown using button 304.

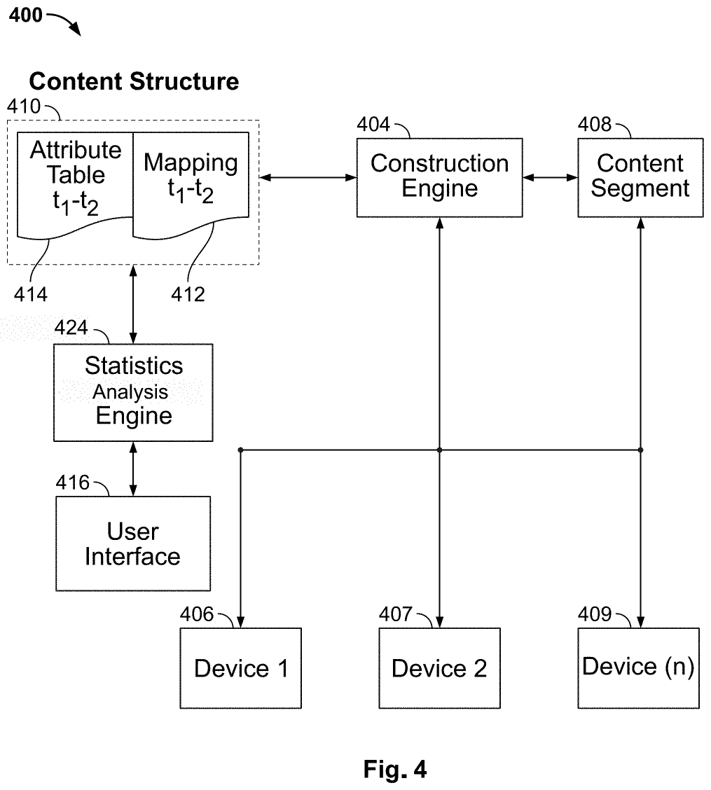

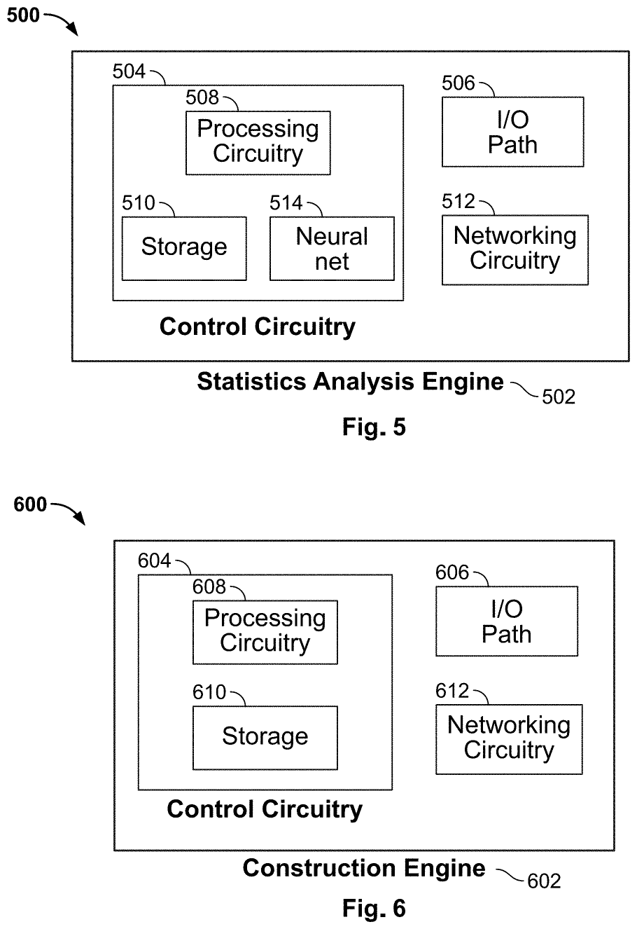

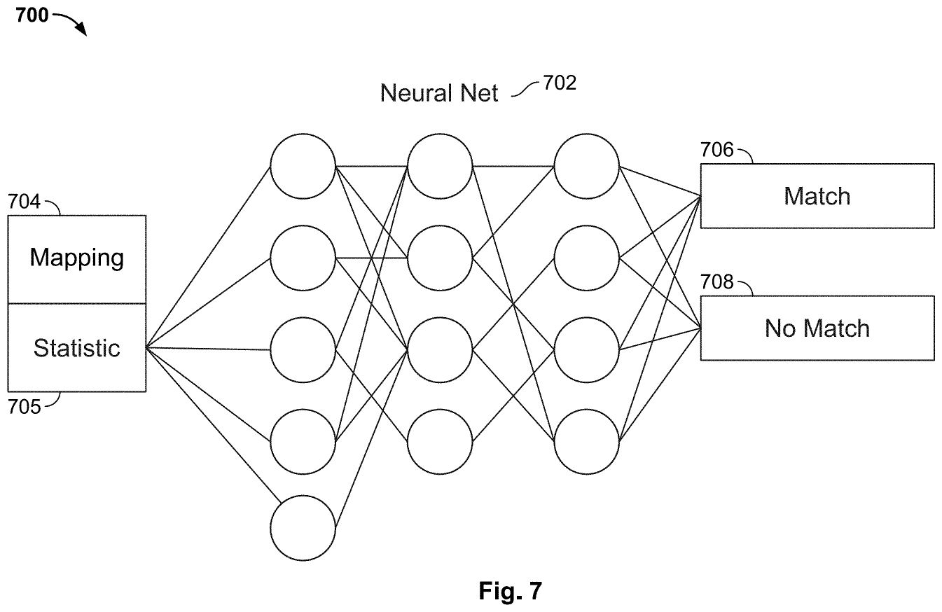

FIG. 4 shows an illustrative system diagram 400 of the statistics engine, the content structure, the construction engine, the content segment, and devices, in accordance with some embodiments of the disclosure. The statistics analysis engine 424 may comprise any suitable hardware that provides for processing and transmit/receive functionality. Statistics analysis engine 424 may be communicatively coupled to multiple electronic devices (e.g., device 1 (406), device 2 (407), device n (409)). Statistics analysis engine 424 may be communicatively coupled to a content structure 410, a construction engine 404, and content segment 408 (e.g., content segment in memory). As illustrated within FIG. 4, a further detailed disclosure on the statistics analysis engine can be seen in FIG. 5 showing an illustrative block diagram of the statistics engine, in accordance with some embodiments of the disclosure. Additionally, as illustrated within FIG. 4, a further detailed disclosure on the construction engine can be seen in FIG. 6 showing an illustrative block diagram of the construction engine, in accordance with some embodiments of the disclosure.

In some embodiments, the statistics analysis engine may be implemented remotely from the devices 406-409 using as a cloud server configuration. The statistics analysis engine may be any device for generating content structures based on statistical data stored on devices 406-409 (e.g., acquired via user interface 416). The statistics analysis engine may be implemented by a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smartphone, or any other television equipment, computing equipment, Internet-of-Things device, wearable device, or wireless device, and/or combination of the same. For example, any device that needs to improve a content segment prior to presentation may include a statistics analysis engine. Any of the system modules (e.g., statistics engine, data structure, ISP, and electronic devices) may be any combination of shared or disparate hardware pieces that are communicatively coupled. In some embodiments, the statistics analysis engine may be implemented on a biological computing device that is operated by specially configured proteins.

In some embodiments, the construction engine may be implemented remotely from the electronic devices 406-409, e.g., via a cloud server configuration. The construction engine may be any device for accessing the content structure and generating content segments as described above. The construction may be implemented by hardware similar to hardware for implementing statistics analysis engine 424. Any of the system modules (e.g., statistics analysis engine data structure, ISP, and electronic devices) may be any combination of shared or disparate hardware pieces that are communicatively coupled.

In some embodiments, statistics analysis engine 424, construction engine 404, and a device from devices 406-409 may be implemented within a single local device. In other embodiments, the statistics analysis engine and construction engine may be implemented within a single local device.

The electronic device (e.g., device 1 (406), device 2 (407), device n (409)) may be any device that has properties to transmit/receive network data as well as an interface to play media content (e.g., touchscreen, speakers, keyboard, voice command input and confirmation, or any other similar interfaces). The devices 406-409 may be implemented using hardware similar to that used implement statistics analysis engine 424.

The content structure 410 may be any database, server, or computing device that contains memory for receiving and transmitting data related to the attribute table 414 and mapping 412. Example data that may be stored in the content structure, as described earlier, can be seen in FIG. 1. The content structure may be cloud-based or integrated into the statistics engine, construction engine, and/or one of the devices 406-409. In some embodiments, the content structure is communicatively coupled to both the statistics analysis engine 424 and the construction engine 404.

The content segment 408 may be any data or information that is generated by the construction engine 404. The content segment may be transmitted by the construction engine 404 to any of the devices 406-409 (e.g., for display on user interface 416). The content segment may be communicatively coupled to the devices 406-409, the construction engine 404, and the statistics analysis engine 424. For example, when content segment 408 needs to be generated, this operation is performed by statistics analysis engine 424 and the new content structure 410 is then rendered using construction engine 404.

FIG. 5 shows an illustrative block diagram 500 of the statistics analysis engine 502 (e.g., statistics analysis engine 414), in accordance with some embodiments of the disclosure. In some embodiments, the statistics analysis engine may be communicatively connected to a user interface and to network circuitry 512 (e.g., for sending and receiving content structures). In some embodiments, the statistics analysis engine may include processing circuitry, control circuitry, and storage (e.g., RAM, ROM, hard disk, removable disk, etc.). The statistics analysis engine may include an input/output path 506. I/O path 506 may provide device information, or other data, over a local area network (LAN) or wide area network (WAN), and/or other content and data to control circuitry 504, which includes processing circuitry 508 and storage 510. Control circuitry 504 may be used to send and receive commands, requests, signals (digital and analog), and other suitable data using I/O path 506. I/O path 506 may connect control circuitry 504 (and specifically processing circuitry 508) to one or more communications paths.

Control circuitry 504 may be based on any suitable processing circuitry such as processing circuitry 508. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 504 executes instructions for statistics analysis engine stored in memory (e.g., storage 510).

Memory may be an electronic storage device provided as storage 510, which is part of control circuitry 504. As referred to herein, the phrase “electronic storage device” or “storage device” should be understood to mean any device for storing electronic data, computer software, or firmware, such as random-access memory, read-only memory, hard drives, solid state devices, quantum storage devices, or any other suitable fixed or removable storage devices, and/or any combination of the same. Nonvolatile memory may also be used (e.g., to launch a boot-up routine and other instructions). In some embodiments, statistics analysis engine 702 also includes neural net 514, which will be described in more detail below.

Statistics analysis engine 502 may be coupled to a communications network via network circuitry 512. The communications network may be one or more networks including the Internet, a mobile phone network, mobile voice or data network (e.g., a 5G, 4G or LTE network), mesh network, peer-to-peer network, cable network, or other types of communications network or combinations of communications networks. Statistics analysis engine 502 may be coupled to a secondary communication network (e.g., Bluetooth, Near Field Communication, service provider proprietary networks, or wired connection) to the selected device for generation for playback. Paths may separately or together include one or more communications paths, such as a satellite path, a fiber-optic path, a cable path, a path that supports Internet communications, free-space connections (e.g., for broadcast or other wireless signals), or any other suitable wired or wireless communications path or combination of such paths.

FIG. 6 shows an illustrative block diagram 600 of the construction engine 602 (e.g., construction engine 404), in accordance with some embodiments of the disclosure. The construction engine may perform each of the operations individually or collaboratively. In some embodiments, the construction engine may be communicatively connected to a user interface. In some embodiments, the construction engine may include processing circuitry, control circuitry, and storage (e.g., RAM, ROM, hard disk, removable disk, etc.). The construction engine may include an input/output path 606. The construction engine may be coupled to a communications network via network circuitry 612. In some embodiments, construction engine 602 includes control circuitry 604 (e.g., similar to control circuitry 504). Control circuitry 604 may include processing circuity 608 and storage 610, that are similar to processing circuity 508 and storage 510, respectively.

FIG. 7 is an illustrative block diagram 700 of neural net 702, in accordance with some embodiments of the disclosure. In some embodiments, neural net 702 may be neural net 514 of FIG. 5. In some embodiments, a statistics analysis engine (e.g., statistics analysis engine 502) may use neural net 702 to perform matching of statistic items to mappings.

In some embodiments, neural net 702 may include multiple neurons (represented as circles in FIG. 7) and connections between neurons (represented as straight lines in FIG. 7). Each neuron may be a data structure with two states (e.g., {1} or {ON} state, and {0} or {OFF} state). Each neuron may have positive or negative connections to neurons of the previous layer and/or to neurons of the next layer. Each connection may be used to communicate the state of the neuron to other neurons. For example, the positive connection may send the state of the neuron, while the negative connection may send the inverse of the state of the neuron. The incoming connections may be used to set the state of the neuron. For example, if more {ON} signals are received than {OFF} signals, the neuron is set to the {ON} state. If more {OFF} signals are received than {ON} signals, the neuron is set to the {OFF} state. In some embodiments, neural net 702 may be fully connected and include a weight for each connection. In this case, neurons are set to incoming values based on weights of the connections. The connections may be added or removed as neural net 702 is trained (e.g., as explained below). The weights may be changed as neural net 702 is trained (e.g., as explained below).

To train neural net 702, the statistics analysis engine may start by accessing a large number (e.g., 10,000) of matched parts of mappings and statistics. For example, games that were deconstructed using a deconstruction engine to generate the mappings may be paired with editor generated statistics. The training set is then inputted into neural net 702. In addition, an equal number of mismatched mappings and statistics are also used in the training set. In some embodiments, the training set may also include human-generated pairs of statistics and plays depicting the statistics. The neural net may result in match output 706 or no match output 708. As training data is fed through neural net 702, connections and weights are then adjusted seeking to maximize the output of neural net 702 matching the expected output (e.g., match output for matches pairs, and no match output for non-matching pairs). In this way, neural network 702 is trained to recognize matches between statistics and mappings. The training may be repeated multiple times and with multiple pairs.

Once trained, the statistics analysis engine may use neural net 702 to decide if a statistic item matches a mapping of an object. For example, statistics analysis engine may input 704 and 705 (e.g., statistic item 110 and mapping of object 120) into neural net 702 and receive a match or no match output. This output may be used to decide whether a matching object was found in step 118.

While a generic artificial neural net is depicted, any other type of neural net can also be used. For example, a Deep Neural Net (DNN) may be implemented by neural net 702 to performed techniques described above and below.

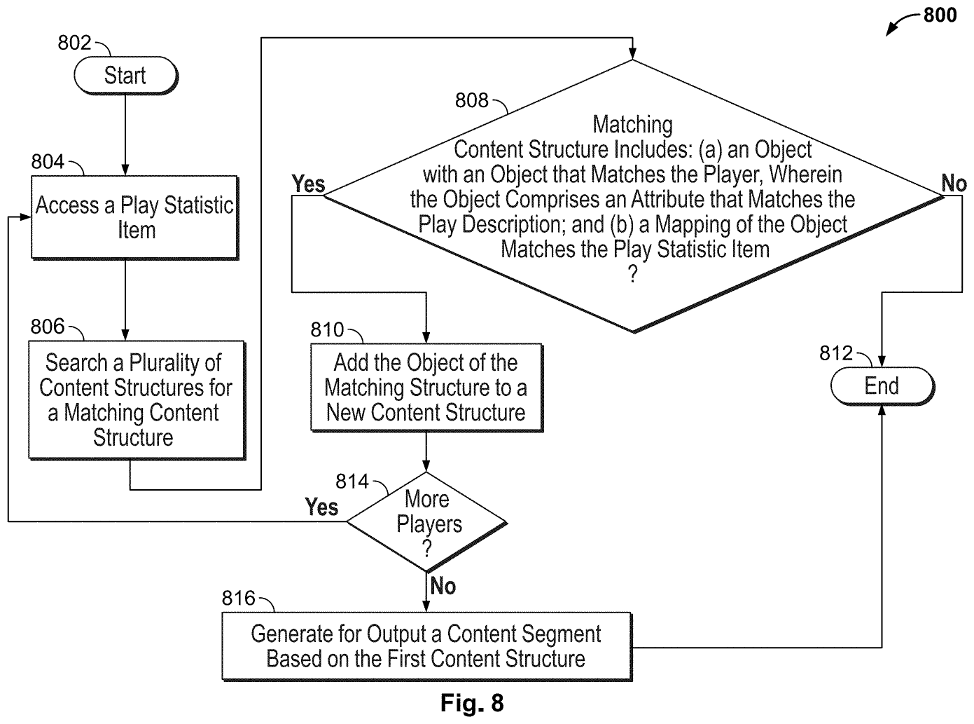

FIG. 8 is an illustrative flowchart of a process 800 for creating content based on statistic items, in accordance with some embodiments of the disclosure. Process 800, and any of the following processes, may be executed by one or more of control circuitry 504 (e.g., in a manner instructed to control circuitry 504 by the instructions stored in storage 510) and control circuitry 604 (e.g., in a manner instructed to control circuitry 604 by the instructions stored in storage 610). Control circuitry 504 may be part of a statistics analysis engine or of a remote server separated from the statistics analysis engine by way of a communications network or distributed over a combination of both.

Process 800 begin at 802. For example, process 800 may begin when a user requests replay or summary of a game based on statistics (e.g., using user interface 300). In some embodiments, process 800 is automatically initiated when game statistic became available (e.g., from a server of a sports website).

At 804, control circuitry 504 may access a statistic item (e.g., item 110), e.g., over a network (for example, from a sports website). In some embodiments, control circuitry 504 may also extract key features of the statistic item, e.g., player name, play duration, play description (e.g., pass, run, kick, etc.)

At 806, control circuitry 504 may access a library of content structures stored in storage 510. For example, the library may store a plurality of content structures generated by the deconstruction engine based on segments of previously recorded sports matches. In particular, control circuitry 504 may check each stored content structure in the library to check for objects that match the statistic item (e.g., by performing a check at step 808.)

At 808, control circuitry 504 may check whether the matching structure includes: (a) an object that matches the player and comprises an attribute that matches the play description; and (b) a mapping of the object matches the play statistic item. For example, to check whether an object matches the player of the statistic item, control circuitry 504 may check if the object has a “name” feature that is equal to the name of the player identified by the statistic item. To check whether the object comprises an attribute that matches the play description, control circuitry 504 may perform natural language processing to check if the features are associated with keywords from the statistic item. For example, the feature “pass” may be related to words “throwing” and “flicking.” In another example the feature “kicking” maybe related to words “field goal” or “extra point.”

In some embodiments, to check whether a mapping of the object matches the play statistic item, control circuitry 504, may check whether the play time is equal or similar (e.g., within 10%) to the length of the relevant mappings (e.g., mappings that matched the play description). In some embodiments, control circuitry 504 may use a neural net (e.g., neural net 514) to check whether the mapping matches the play, for example, as described in FIG. 7. If a matching content structure is found, process 800 proceeds to 810; otherwise process 800 ends at 812.

At 810, control circuitry 504 adds the object of the identified structure to a new content structure. For example, the object may be added sequentially after previous added objects. In some embodiments, the object may be modified, e.g., by removal of features that are not related to the statistic item accessed at 804, or by condensing the mapping to create a summary. In some embodiments, control circuitry 504 may modify the object to include an overlay of the text of the statistic.

At 814, control circuitry 504 checks if more plays are available. If so, control circuitry 504 repeats process 800 starting from 804 by accessing the next item. If no more statistics items are available (e.g., because all play-by-play statistics of a particular game are exhausted), control circuitry 504 proceeds to 816

At 816, a control circuitry (e.g., control circuitry 604 of construction engine 602) may generate for output a content segment based on the new content structure. For example, the content segment may be generated for display on a screen of a user device, or for transmission via a network. The construction of a content segment based on a content structure is described in more detail in the '823 application. In some embodiments, the content segments may include a text overlay of the text of the statistic item (e.g., as shown by element 138 of FIG. 1).

It is contemplated that the steps or descriptions of FIG. 8 may be used with any other suitable embodiment of this disclosure. In addition, suitable steps and descriptions described in relation to FIG. 8 may be done in alternative orders or in parallel to further the purposes of this disclosure. For example, suitable steps may be performed in any order or in parallel or substantially simultaneously to reduce lag or increase the speed of the system or method. Some of the suitable steps may also be skipped or omitted from the process. Furthermore, it should be noted that any of the devices or equipment discussed in relation to FIGS. 4, 5 and 6 could be used to perform one or more of the steps in FIG. 8.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Furthermore, it should be noted that the features and limitations described in any one embodiment may be applied to any other suitable embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for generating content for sports data, the method comprising:
accessing a play statistic item, the play statistic item comprising a player name, play duration, and play description;
searching a plurality of content structures for a matching content structure that comprises:
(a) an object that matches the player and comprises an attribute that matches the play description; and
(b) a mapping of the object that matches the play statistic item;
in response to the search identifying the matching content structure, adding the object and the mapping to a new content structure; and
generating for output a content segment based on the new content structure.

2. The method of claim 1, further comprising performing the steps of claim 1 for a plurality of statistic items of a game to generate the new content structure.

3. The method of claim 1, further comprising:
receiving a selection of replay length; and
performing the steps of claim 1 for a subset of statistic items of a game to generate the new content structure, wherein the new content structure comprises a plurality of mappings having total length equal to the replay length.

4. The method of claim 1, further comprising:
receiving a selection of a key player; and
performing the steps of claim 1 for a subset of statistic items of a game that includes the name of the key player to generate the new content structure.

5. The method of claim 1, wherein determining that the object matches the player comprises determining that the object title matches the player's name.

6. The method of claim 1, wherein determining that the object matches the player comprises determining that physical features of the object match physical features of the player.

7. The method of claim 1, wherein determining that the mapping of the object matches the play statistic item comprises determining that the mapping of the object comprises length that matches the play duration.

8. The method of claim 1, wherein determining that the mapping of the object matches the play statistic item comprises inputting the mapping of the object and the play statistic item into a neural net.

9. The method of claim 1, wherein the neural net is trained using a set of mappings and matching play statistic items.

10. The method of claim 1, wherein generating for output the content segment comprises overlaying the play statistic item over the content segment.

11. A system for generating content for sports data, the system comprising:
control circuitry configured to:
access a play statistic item, the play statistic item comprising a player name, play duration, and play description;
search a plurality of content structures for a matching content structure that comprises:
(a) an object that matches the player and comprises an attribute that matches the play description; and
(b) a mapping of the object that matches the play statistic item; and
in response to the search identifying the matching content structure, add the object and the mapping to a new content structure; and
construction engine configured to:
generate for output a content segment based on the new content structure.

12. The system of claim 11, wherein the control circuitry is configured to performing the functions of claim 11 for a plurality of statistic items of a game to generate the new content structure.

13. The system of claim 11, wherein the control circuitry is configured to:
receive a selection of replay length; and
perform the functions of claim 11 for a subset of statistic items of a game to generate the new content structure, wherein the new content structure comprises a plurality of mappings having total length equal to the replay length.

14. The system of claim 11, further wherein the control circuitry is configured to:
receive a selection of a key player; and
perform the functions of claim 11 for a subset of statistic items of a game that includes the name of the key player to generate the new content structure.

15. The system of claim 11, wherein the control circuitry is configured to determine that the object matches the player by determining that the object title matches the player's name.

16. The system of claim 11, wherein the control circuitry is configured to determine that the object matches the player by determining that physical features of the object match physical features of the player.

17. The system of claim 11, wherein the control circuitry is configured to determine that the mapping of the object matches the play statistic item by determining that the mapping of the object comprises length that matches the play duration.

18. The system of claim 11, wherein the control circuitry is configured to determine that the mapping of the object matches the play statistic item by inputting the mapping of the object and the play statistic item into a neural net.

19. The system of claim 11, wherein the neural net is trained using a set of mappings and matching play statistic items.

20. The system of claim 11, wherein the construction engine is configured to determine for output the content segment by overlaying the play statistic item over the content segment.

21-30. (canceled)
